(19) United States
(12) Patent Application Publication
(10) Pub. No.: US 2025/0313494 A1
(43) Pub. Date: Oct. 9, 2025

(54) Water Treatment Devices and Methods

(71) Applicant: UpTerra Corporation, San Rafael, CA (US)

(72) Inventor: Ahmad Reza Givsan, San Rafael, CA (US)

(21) Appl. No.: 18/860,491

(22) PCT Filed: Apr. 27, 2023
(86) PCT No.: PCT/US2023/020281

§ 371 Date: Oct. 25, 2024

Related U.S. Application Data
(60) Provisional application No. 63/335,544, filed on Apr. 27, 2022.
(60) Provisional application No. 63/419,296, filed on Oct. 25, 2022.

(51) Int. Cl. C02F 1/30; A01G 7/04; C02F 1/48

(52) U.S. Cl. CPC C02F 1/30; A01G 7/04; C02F 1/487

(57) ABSTRACT

A device for treating a fluid is described. The device includes a first tube having an inlet and an outlet configured to provide a passageway for flow of the fluid. Multiple crystals are disposed near the fluid flowing through the tube. The device alsos includes a source of electromagnetic radiation that irradiates the multiple crystals, which changes the fluid's structure. A method of providing a fluid for biologic consumption is also described. The method includes the steps of patterning an electromagnetic field to achieve a desired outcome for an organism, exposing the fluid and one or more crystals to the patterned electromagnetic field, and applying the exposed fluid to the organism. The organism can be an animal or a plant and the desired outcome can be improved growth or health.

This application is a national stage filing of PCT/US23/20281, filed on Apr. 27, 2023, which claims the benefit of priority of U.S. provisional application Ser. No. 63/335,544, filed on Apr. 27, 2022 and U.S. provisional application Ser. No. 63/419,296, filed on Oct. 25, 2022.

### FIELD OF THE INVENTION

The field of the invention is water treatment, in particular, infoceuticals.

### BACKGROUND

The background description includes information that may be useful in understanding the present inventive subject matter. It is not an admission that any of the information provided herein is prior art or relevant to the presently claimed invention, or that any publication specifically or implicitly referenced is prior art. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

It is well known that water molecules will organize into clusters or “coherent domains” when exposed to electromagnetic fields, due to change in molecule oscillations. US2006/0273020 to Bagley, for example, teaches using an oscillating crystal to modify or “structure” water molecule clusters. Bagley also teaches connecting the crystal to a battery to oscillate the crystals at specific frequencies for different purposes. US20140170059 to Czech teaches using electrodes and salt in water to electrically discharge water clusters and improve efficacy against micro-organisms. US20210228718 to Camisasca teaches irradiating water with light energies at specific combinations of frequency ranges to medically treat patients suffering from poor sense of balance.

Researchers have recently discovered that the unique electromagnetic spectrum or signal of a substance, such as a pharmaceutical, can be captured, recorded, digitized, and artificially reproduced. More importantly, researchers found that, when unstructured water molecules are exposed to an artificially reproduced electromagnetic signal of a substance, the water molecules will organize into coherent domains that match the artificially reproduced electromagnetic signal. This is apparently true even when the electromagnetic signal comprises multiple frequencies because unstructured water molecules will match oscillations of the frequency to which they are nearest, such that the water will contain coherency domains oscillating at different frequencies.

Surprisingly, researchers found that structured water can often influence the environment and produce the same benefits as the substance whose electromagnetic signal is being mimicked. This new technology has incredible potential, with new applications being discovered each day. For example, it has been shown that cell receptors in plants and animals will respond to the electromagnetic field of structured water as if they had encountered the substance being mimicked. This new field has been called “infoceuticals.”

It would be advantageous to provide devices, systems, and methods for further improving the efficacy of this new technology.

Thus, there remains a need for improved devices, systems, and methods for structuring fluids.

### SUMMARY OF THE INVENTION

The inventive subject matter provides methods and devices for treating a fluid, comprising a first tube having an inlet and an outlet configured to provide a passageway for flow of the fluid, multiple crystals disposed near the fluid flowing through the tube, and a source of electromagnetic radiation disposed to irradiate the multiple crystals.

In some embodiments, the first tube is disposed within a second tube, and the multiple crystals are disposed within a space between the first and second tubes. In other embodiments, the first tube is disposed about a second tube, and the multiple crystals are disposed within the second tube. In yet other embodiments, the multiple crystals are disposed within (e.g., inside) the first tube. However, it is also contemplated that the multiple crystals are affixed about the first tube (e.g., affixed to the outside the first tube, or embedded within the walls of the first tube).

In some embodiments, the multiple crystals are quartz, copper, iron, a piezoelectric oscillator, and/or a paramagnetic material. It is contemplated that the multiple crystals can have a lattice structure selected from the group consisting of cubic, isometric, tetragonal, orthorhombic, hexagonal, trigonal, triclinic, and monoclinic. In some embodiments, the multiple crystals have a geometrically symmetrical lattice structure.

In other aspects of some embodiments, the electromagnetic radiation can have a wavelength of 104 m to 10-12 m, a minimum intensity of 10 VPP to 50 VPP, and a duty cycle of 23-72. The electromagnetic radiation is preferably produced using longitudinal interferometry, whereby electromagnetic field lines are mixed thus that geometric field lines of coherence are produced increasing frequency resonance with the fluid medium being structured through the physical device principles.

The inventive subject matter also includes a method of providing a fluid for biologic consumption, comprising: (i) patterning an electromagnetic field to achieve a desired outcome for an organism; (ii) exposing the fluid to each of (a) the patterned electromagnetic field, and (b) a crystal; and (iii) applying the exposed fluid to the organism. The step of patterning the electromagnetic field can comprise obtaining a radiation signature by subjecting a substance to a frequency sweep, and artificially generating at least a portion of the signature. It is contemplated that the organism can be an animal, a plant, or a seed and the desired outcome can be increased growth and/or improved health. In such embodiments, the radiation signature can be patterned after a nutrient, fertilizer, insecticide, or other substance that is beneficial to the organism.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a device for treating a fluid.

FIG. 2 is a schematic of another device for treating a fluid.

FIG. 3 is a schematic of another device for treating a fluid

FIG. 4 is a schematic of another device for treating a fluid.

FIG. 5 is a schematic of another device for treating a fluid.

FIG. 6 is a schematic of another device for treating a fluid.

FIG. 7 is a prior art image of unstructured water.

FIG. 8 is an image of structured water.

FIG. 9 is another image of structured water.

FIG. 10 is another image of structured water.

FIG. 11 is another image of structured water.

FIG. 12 is another image of structured water.

FIG. 13 is another image of structured water.

FIG. 14 is another image of unstructured water.

FIG. 15 is another image of unstructured water.

FIG. 16 is another image of unstructured water.

FIG. 17 is a photographic side view of four potted plants, showing different growth rates. D1.1 and D2.1 were fed structured water. D1.2 and D2.2 were fed unstructured water.

FIG. 18 is a photographic top view of the four plants of FIG. 17.

FIG. 19 shows a theoretical structure of accepted water molecule bond arrangements, and state of charge to mineral constituents in the medium.

FIGS. 20-23 demonstrate a process of structuring water molecules.

FIGS. 24 and 25 show a device and process for patterning and imprinting structured water.

FIG. 26 shows a different device and process for patterning and imprinting structured water.

### DETAILED DESCRIPTION

The following discussion provides many example embodiments of the inventive subject matter. The embodiments described herein are not intended to be an exhaustive list or to limit the inventive subject matter to the precise form disclosed. The disclosed embodiments are chosen and described to merely explain the principles of the inventive subject matter and its application and practical use so as to enable others skilled in the art to follow its teachings.

The inventive devices, systems, and methods will be understood, both as to its structure and operation, from the accompanying drawings, taken in conjunction with the accompanying description. Although each embodiment represents a single combination of inventive elements, the inventive subject matter is considered to include all possible combinations of the disclosed elements. As such, it should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise. Thus, if one embodiment comprises elements A, B, and C, and a second embodiment comprises elements B and D, then the inventive subject matter is also considered to include other remaining combinations of A, B, C, or D, even if not explicitly disclosed.

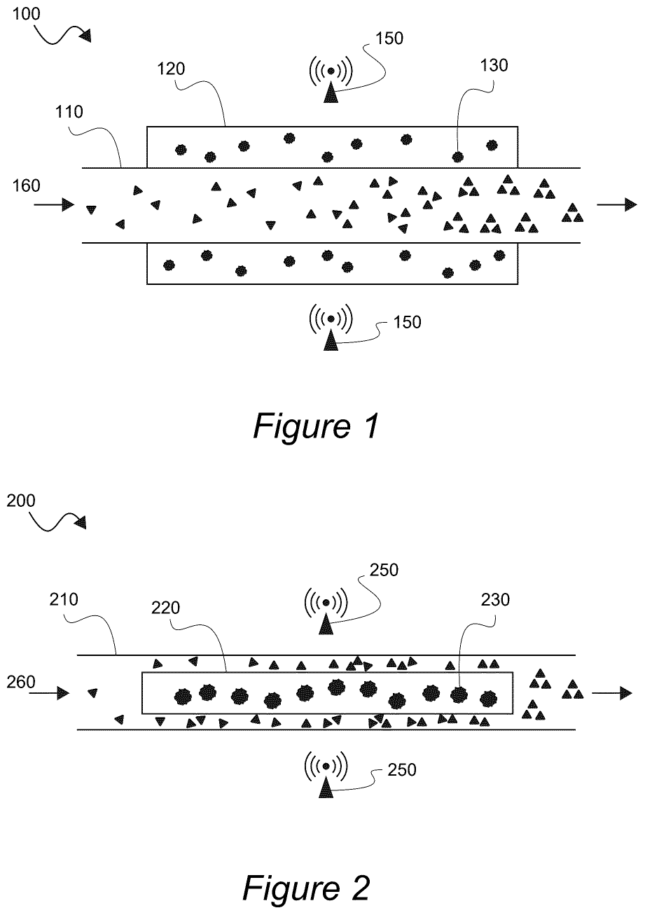

FIG. 1 shows a device 100 for treating a fluid. Device 100 comprises a first tube 110 disposed within a second tube 120. A plurality of crystals 130 are disposed inside the lumen of a second tube 120, and within a space between the first tube 110 and the second tube 120. A source of electromagnetic radiation 150 is disposed near the crystals 130 and irradiates the crystals 130 as a fluid 160 flows through first tube 110 in the direction shown by the arrows.

First tube 110 and second tube 120 can be made of plastic or any material suitable for containing the crystals 130 and/or fluid 160. The first tube 110 and second tube 120 are basically just used to provide passageways. They can have circular, oblong, rectangular, irregular, or any other cross-sections.

It is contemplated that the multiple crystals 130 can be selected the group consisting of quartz, copper, iron, piezoelectric oscillators, and paramagnetic materials. What is potentially more important than the material is the lattice structure of the crystals. Contemplated crystals 130 can have a lattice structure selected from the group consisting of cubic, isometric, tetragonal, orthorhombic, hexagonal, trigonal, triclinic, and monoclinic. In other aspects, the crystals 130 can have a geometrically symmetrical lattice structure. Crystals 130 can have a size ranging from 5 mm to 120 mm. Those of skill in the art will appreciate that the figures are not to scale and the size of the crystals 130 and water molecules have been exaggerated for conceptual purposes.

In some embodiments, the electromagnetic radiation can have a wavelength of 10⁴ m to 10⁻¹² m, an intensity of 25 dB to 120 db, and a duty cycle of 23 to 72. The electromagnetic radiation is preferably produced using longitudinal interferometry, whereby electromagnetic field lines are mixed thus that geometric field lines of coherence are produced increasing frequency resonance with the fluid medium being structured through the physical device principles.

In preferred embodiments, the fluid 160 comprises water. However, fluid 160 could comprise any fluid that has molecules capable of being arranged or structured when exposed to electromagnetic radiation, according to the principles of water coherency as described in numerous recent publications. See for example, https://www.infopathy.com/en/publications.

As fluid 160 passes through tube 110 in the direction shown by the arrows, the electromagnetic radiation field 150 causes the water molecules to arrange in coherency domains that mimic the frequencies in electromagnetic radiation field 150. At the same time, electromagnetic radiation field 150 causes the multiple crystals 130 to vibrate, which further facilitates structuring of the water and/or other fluid molecules. The crystals are structuring the fluid medium by way of phase conjugation and charge distribution caused by the flow of the fluid medium over the geometric alignment of the crystal in the flow device, as well the electromagnetic radiations can create similar effects, but generally take much more time, therefore we have found that the mechanical process structures liquid medium water into coherence rather instantly and the arrays or electromagnetic radiation can amplify the structured principles as well as influence information being sent to the fluid medium in a structured state. Crystals and mechanical principles of the claims=structure, electromagnetic principles of the claims=information embedding.

FIG. 2 shows another device 200 for treating a fluid. Device 200 comprises a first tube 210 disposed about a second tube 220. A plurality of crystals 230 are disposed inside second tube 220. A source of electromagnetic radiation 250 is disposed near the crystals 230 and irradiates the crystals 230 as a fluid 260 flows through first tube 210 in the direction shown by the arrows and around tube 220. The irradiating crystals 230 and electromagnetic field 250 cause the molecules of fluid 260 to structure in coherent domains that mimic field 250. Fluid 260 can then be delivered to a target to produce a desired outcome. It is further contemplated that second tube 220 could be porous so that passing fluid comes in direct contact with crystals.

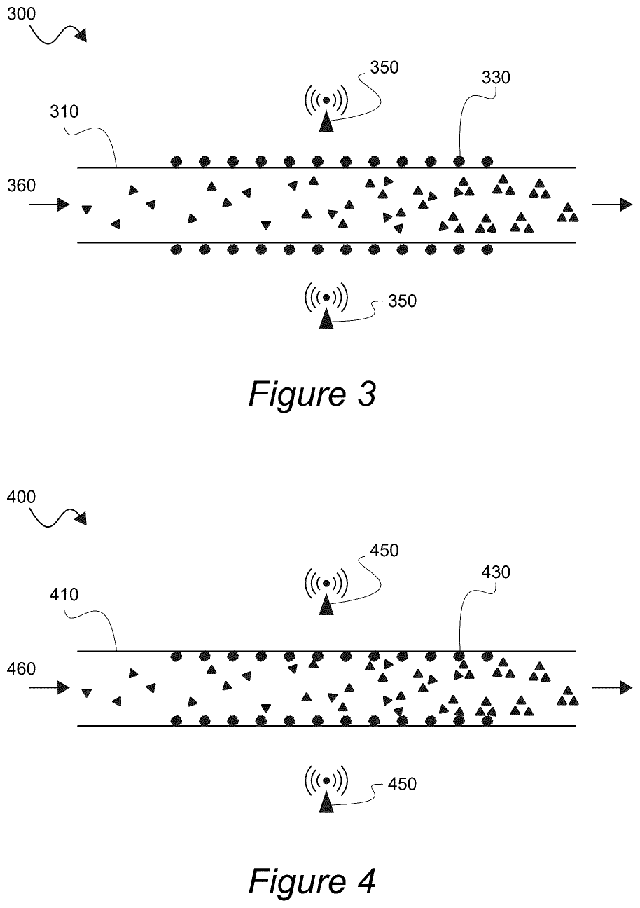

FIG. 3 shows another device 300 for treating a fluid. Device 200 comprises a first tube 310 and a plurality of crystals 330 disposed on, and/or affixed to, an exterior surface of tube 310. A source of electromagnetic radiation 350 is disposed near the crystals 330 and irradiates the crystals 330 as a fluid 360 flows through first tube 310 in the direction shown by the arrows. The irradiating crystals 330 and electromagnetic field 350 cause the molecules of fluid 360 to structure in coherent domains that mimic field 350. Fluid 360 can then be delivered to a target to produce a desired outcome.

FIG. 4 shows another device 400 for treating a fluid. Device 400 is similar to device 300 except that crystals 430 are affixed to an interior surface of first tube 410. In yet other embodiments, it is contemplated that crystals 430 are imbedded in the wall of first tube 410.

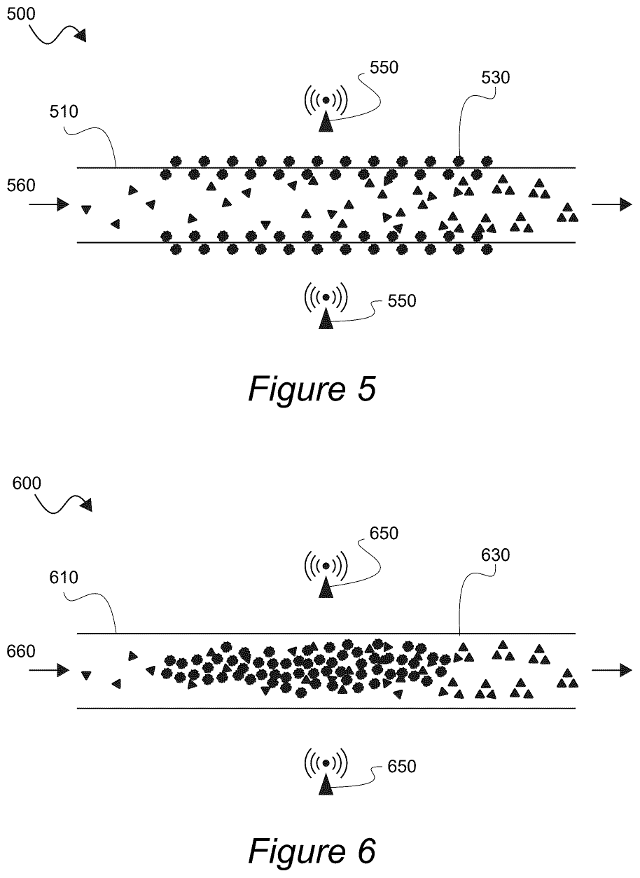

FIG. 5 shows another device 500 for treating a fluid. Device 500 is a combination of device 300 and 400. Crystals 330 disposed on both the exterior and interior surface of tube 510.

FIG. 6 shows another device 600 for treating a fluid. Device 600 comprises a first tube 610 and a plurality of crystals 630 disposed in fluid 660. A source of electromagnetic radiation 650 is disposed near the crystals 630 and irradiates the crystals 630 as a fluid 660 flows through first tube 610 in the direction shown by the arrows. The irradiating crystals 630 and electromagnetic field 650 cause the molecules of fluid 660 to structure in coherent domains that mimic field 650. Fluid 660 can then be delivered to a target to produce a desired outcome. Crystals 630 can be removed from fluid 660 prior to delivery to the target.

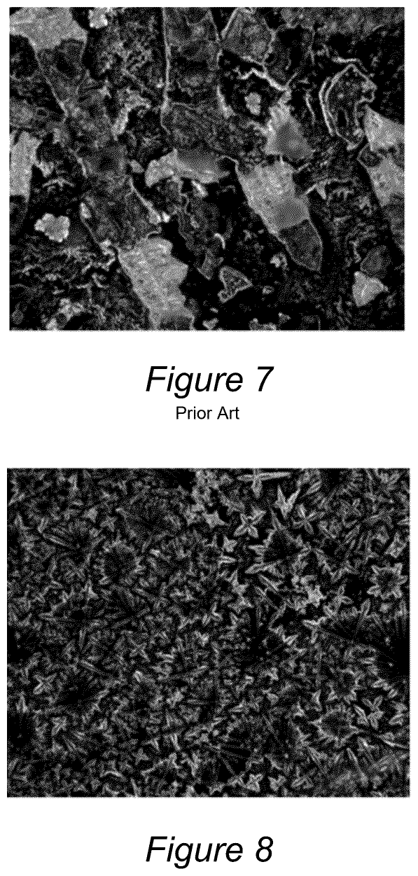

FIG. 7 is an image of unstructured municipal water 9% dilution by volume of Sodium Chloride showing the mineral structure under 40× magnification under dark field microscopy.

FIG. 8 is an image of structured municipal water 9% dilution by volume of Sodium Chloride under 40× magnification under dark field microscopy. The water was irradiated by an electromagnetic signature and demonstrates the structural and energetic phase shifts in the fluid due to the electromagnetic signature.

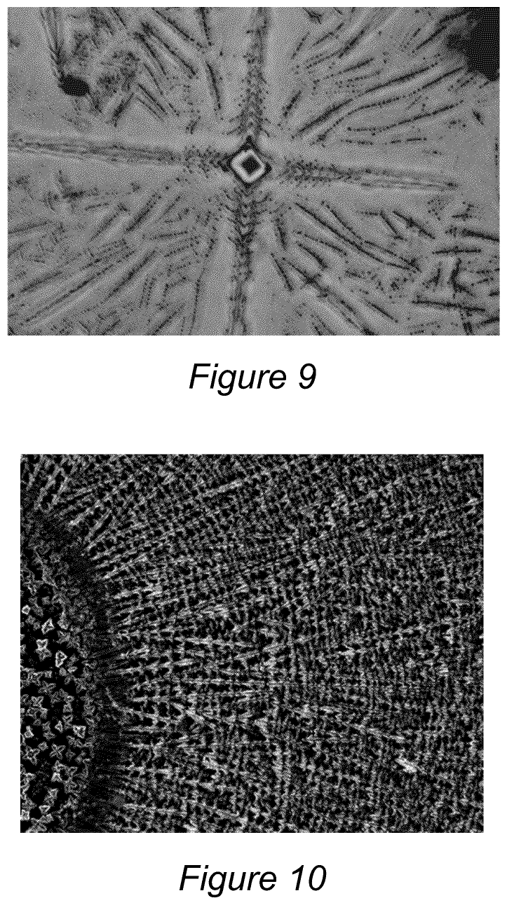

FIG. 9 is an image of structured municipal water 9% dilution by volume of Sodium Chloride under 100× magnification under phase 1 light field microscopy. The water was irradiated by an electromagnetic signature and demonstrates the structural and energetic phase shifts in the fluid due to the electromagnetic signature.

FIG. 10 is an image of structured municipal water 9% dilution by volume of Sodium Chloride under 20× magnification under dark field microscopy. The water was irradiated by an electromagnetic signature and demonstrates the structural and energetic phase shifts in the fluid due to the electromagnetic signature

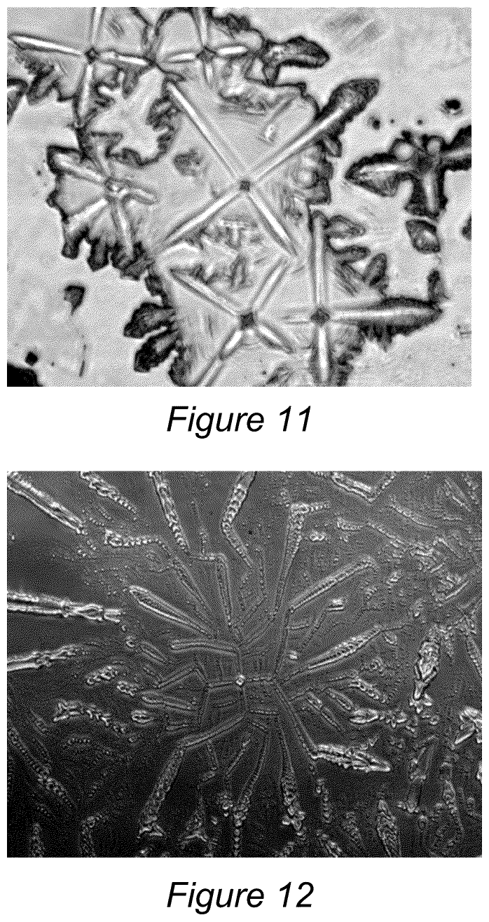

FIG. 11 is an image of structured municipal water 9% dilution by volume of Sodium Chloride under 60× magnification under phase 2 light field microscopy. The water was irradiated by an electromagnetic signature and demonstrates the structural and energetic phase shifts in the fluid due to the electromagnetic signature.

FIG. 12 is an image of structured municipal water 9% dilution by volume of Sodium Chloride under 40× magnification under dark field microscopy. The water was irradiated by an electromagnetic signature and demonstrates the structural and energetic phase shifts in the fluid due to the electromagnetic signature.

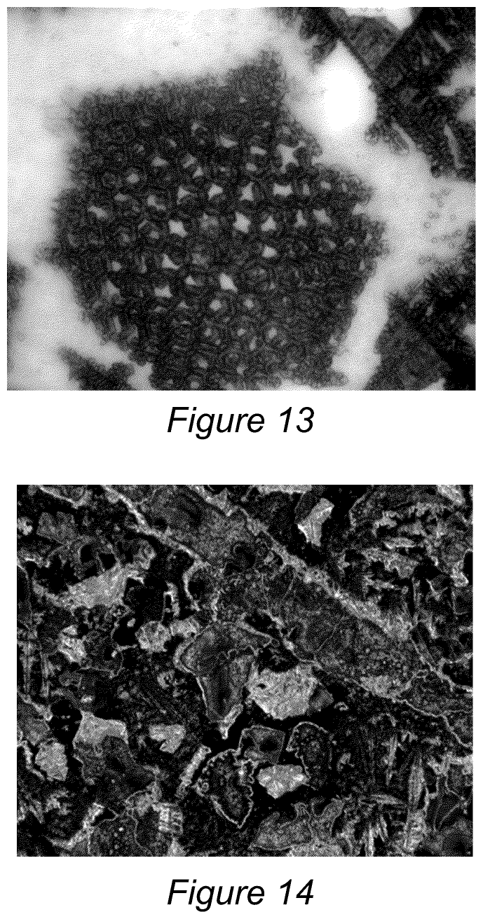

FIG. 13 is an image of structured municipal water 9% dilution by volume of Sodium Chloride under 60× magnification under dark field microscopy. The water was irradiated by an electromagnetic signature and demonstrates the structural and energetic phase shifts in the fluid due to the electromagnetic signature.

FIG. 14 is an image of unstructured municipal water 9% dilution by volume of Sodium Chloride showing the mineral structure under 40× magnification under dark field microscopy.

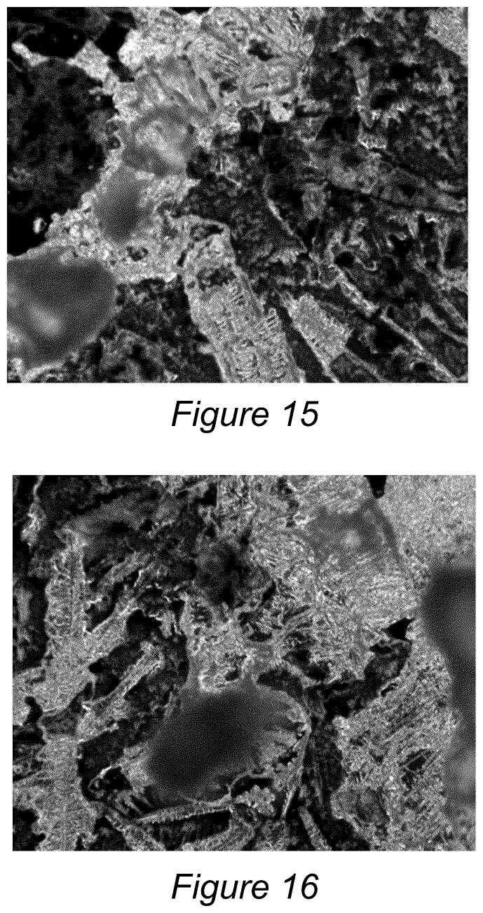

FIG. 15 is an image of unstructured municipal water 9% dilution by volume of Sodium Chloride showing the mineral structure under 60× magnification under dark field microscopy.

FIG. 16 is an image of unstructured municipal water 9% dilution by volume of Sodium Chloride showing the mineral structure under 60× magnification under dark field microscopy.

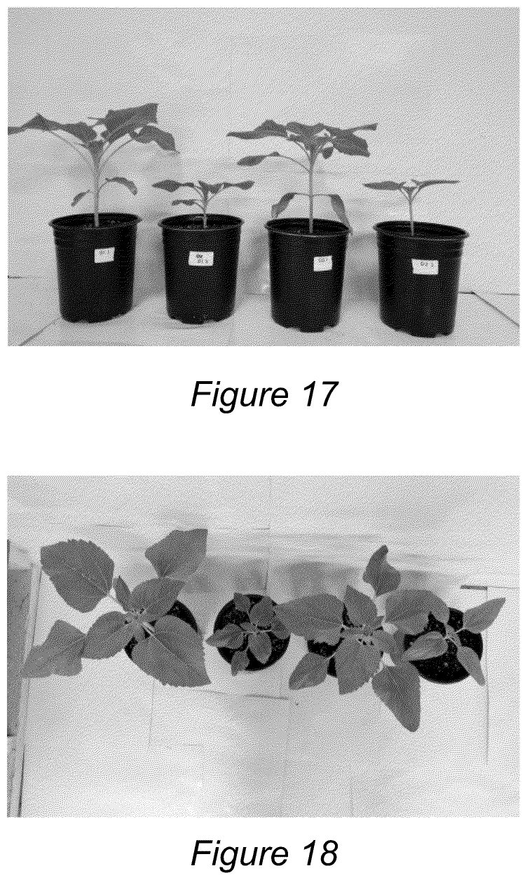

FIG. 17 is a photographic side view of four sunflower plants, labeled as D1.1, D1.2, D2.1, and D2.1.

FIG. 18 is a photographic side top of the same four plants. The seeds were all planted on the same day and were grown under the same conditions except that D1.1 and D2.1 were fed structured water while D1.2 and D2.2 were fed unstructured water. The figures show how structured water significantly increased growth.

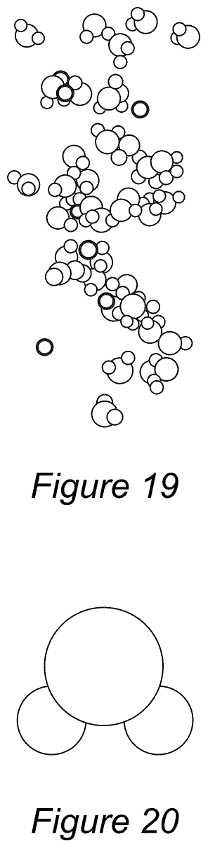

As used herein, a “structured” fluid means the molecules of the fluid have been organized into clusters that mimic an intended electromagnetic field. FIG. 19 shows a theoretical structure of accepted water molecule bond arrangements, and state of charge to mineral constituents in the medium.

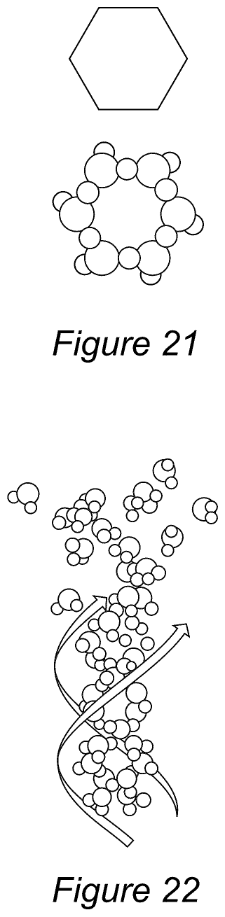

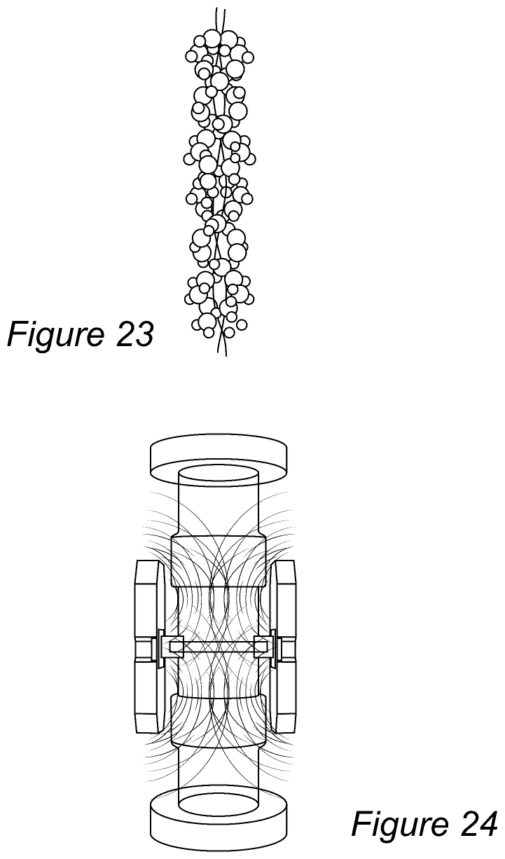

FIGS. 20-23 demonstrate a process of structuring water molecules. FIG. 20 shows an individual water molecule. When a plurality of nearby individual water molecules are exposed to electromagnetic radiation field 150 in the presence of crystals 130, the molecules cluster into a hexagonal shape as shown in FIG. 21 and begin to form a liquid crystal double helix as shown in FIG. 22 until a long double helix structure is formed, as shown in FIG. 23. Clustered structures tend to have the appearance of a crystal and will oscillate at the same frequencies as the electromagnetic radiation field 150. There is no information patterning described by these images. They represent the difference between bulk water and structured energized water.

The electromagnetic radiation field 150 can be configured to pattern a specific substance or substances to achieve a desired outcome in a target such as an organism or material. For example, in one implementation, the substance being mimicked can comprise a nutrient, a fertilizer, or an insecticide. Once the water is structured to mimic the electromagnetic field of fertilizer or insecticide, the structured water is then delivered to an organism such as an animal, seed, plant, crop, or agricultural field to increase growth or health of the organism. It is contemplated that the fluid can be structured to mimic any substance that affects health of an organism, either in a positive way or a negative way. For example, the fluid can be structured to mimic a substance that is harmful for weeds to prevent their growth.

From a methods perspective, the inventive subject matter includes devices, systems, and methods for providing a fluid for a biologic consumption comprising (i) patterning an electromagnetic field to achieve a desired outcome for an organism, (ii) exposing the fluid to each of (a) the patterned electromagnetic field, and (b) a crystal, and (iii) applying the exposed fluid to the organism.

The step of patterning the electromagnetic field can comprise obtaining a radiation signature of a substance by subjecting the substance to a frequency sweep, and artificially generating at least a portion of the signature. In some embodiments, the radiation signature spans at least 1 Hz to 60,000,000 Hz. It is further contemplated that the radiation signature can comprise different amplitudes at different frequencies. The process for patterning (e.g., recording, digitizing) the electromagnetic pattern or signal of a substance and imprinting that signal onto water is disclosed in further detail in provisional application No. 63/410,324 filed on Sep. 27, 2022, which is incorporated herein by reference. In this application, patterning is imprinting, although patterning is a better descriptor technically.

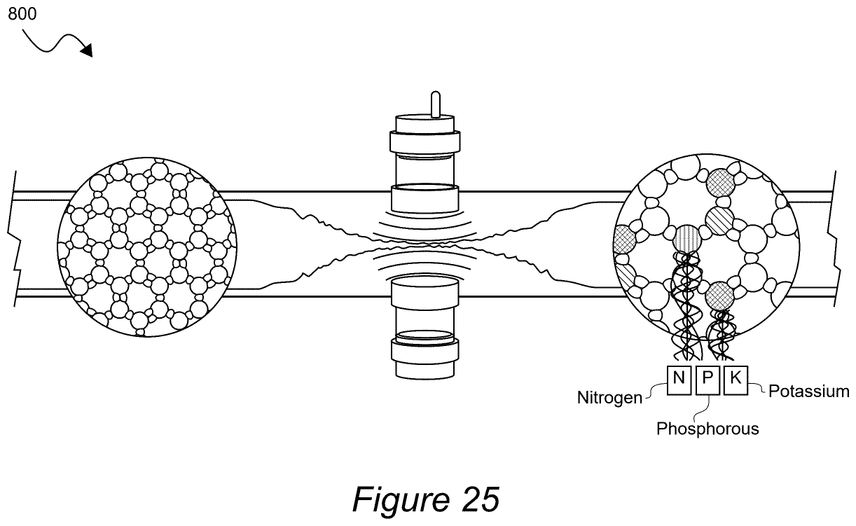

FIGS. 24 and 25 show a device and process for patterning and imprinting structured water.

The method can also comprise (i) recording an electromagnetic signature of a substance having relevance to a plant, animal, or other target, (ii) treating the fluid by reproducing the electromagnetic signature of the substance and exposing the fluid to the signature, and (iii) applying the treated water to the target. The step of exposing the fluid to the signature can comprise flowing the fluid past the crystals and the electromagnetic field. However, it is also contemplated that the fluid can be treated while it is either stationary and/or contained within a closed volume.

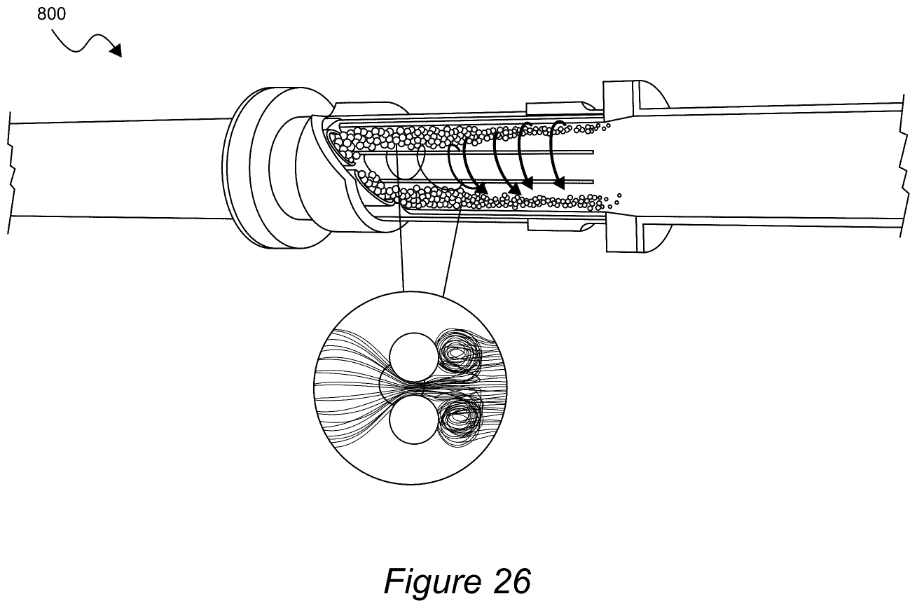

FIG. 26 shows a different device and process for patterning and imprinting structured water.

The recitation of ranges of values herein is merely intended to serve as a shorthand method of referring individually to each separate value falling within the range. Unless the context dictates the contrary, all ranges set forth herein should be interpreted as being inclusive of their endpoints, and open-ended ranges should be interpreted to include only commercially practical values. Similarly, all ranges and all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the claims unless explicitly stated or context dictates otherwise. No language in the specification should be construed as indicating any non-claimed element essential to the practice of the inventive subject matter.

Groupings of alternative elements or embodiments disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A device for treating a fluid, comprising:
a first tube having an inlet and an outlet configured to provide a passageway for flow of the fluid;
a plurality of crystals having a size ranging from 5 mm to 120 mm disposed inside or around the passageway; and
a source of electromagnetic radiation disposed to irradiate the plurality of crystals.

2. The device of claim 1, wherein the first tube is disposed within a second tube, and the plurality of crystals are disposed within a space between the first and second tubes.

3. The device of claim 1, wherein the first tube is disposed about a second tube, and the plurality of crystals are disposed within the second tube.

4. The device of claim 1, wherein the plurality of crystals are disposed within the first tube.

5. The device of claim 1, wherein the plurality of crystals are affixed about the first tube.

6. The device of claim 1, wherein the plurality of crystals are selected from the group consisting of quartz, copper, iron, a piezoelectric oscillator, and a paramagnetic material.

7. The device of claim 1, wherein the plurality of crystals have a lattice structure selected from the group consisting of cubic, isometric, tetragonal, orthorhombic, hexagonal, trigonal, triclinic, and monoclinic.

8. The device of claim 1, wherein the plurality of crystals have a geometrically symmetrical lattice structure.

9. The device of claim 1, wherein the electromagnetic radiation has a wavelength of 104 m to 10-12 m.

10. The device of claim 1, wherein the electromagnetic radiation has a minimum intensity of 10 VPP to 50 VPP.

11. The device of claim 1, wherein the electromagnetic radiation has a duty cycle of 23-72.

12. A method of providing a fluid for a biologic consumption, comprising:
patterning an electromagnetic field to achieve a desired outcome for an organism;
exposing the fluid to each of (a) the patterned electromagnetic field, and (b) a crystal; and
applying the exposed fluid to the organism.

13. The method of claim 12, wherein the step of patterning the electromagnetic field comprises obtaining a radiation signature by subjecting a substance to a frequency sweep, and artificially generating at least a portion of the signature.

14. The method of claim 13, wherein the radiation signature spans at least 1 Hz to 60,000,000 Hz.

15. The method of claim 13, wherein the substance comprises a fertilizer.

16. The method of claim 13, wherein the substance comprises an insecticide.

17. The method of claim 12, wherein the desired outcome comprises increasing growth of a plant, and the organism is a seed of the plant.

18. The method of claim 12, wherein the organism is a crop plant, and wherein the step of applying the exposed fluid to the organism comprises applying the exposed fluid to an agricultural field that contains multiple instances of the crop plant.

19. The method of claim 12, wherein the organism is an animal, and the desired outcome comprises improved health of the animal.
